(19) United States
(12) Patent Application Publication
(10) Pub. No.: US 2026/0339415 A1
(43) Pub. Date: Oct. 29, 2026

(54) POWER-SAVING EVALUATION SYSTEM

(71) Applicant: NTT DOCOMO, INC., Tokyo (JP)

(72) Inventors: Fumiaki IGARASHI, Chiyoda-ku (JP); Masayasu SUMIYA, Chiyoda-ku (JP)

(73) Assignee: NTT DOCOMO, INC., Tokyo (JP)

(21) Appl. No.: 19/115,318

(22) PCT Filed: Oct. 6, 2023
(86) PCT No.: PCT/JP2023/036587

§ 371 Date: Mar. 26, 2025

(30) Foreign Application Priority Data
Nov. 1, 2022 (JP) 2022-175513

(51) Int. Cl. G06F 1/3206

(52) U.S. Cl. CPC G06F 1/3206

(57) ABSTRACT

A power-saving evaluation system is a system that evaluates power-saving behavior of a user with respect to a power consumption device, the power-saving evaluation system including: a radio wave intensity information acquisition unit configured to acquire radio wave intensity information indicating an intensity of a radio wave related to short-range wireless communication, the radio wave being transmitted from the power consumption device and detected in a device carried by the user; an operation estimation unit configured to estimate whether or not the user is operating the power consumption device based on the radio wave intensity information; a power consumption information acquisition unit configured to acquire power consumption information indicating the power consumption of the power consumption device; and an evaluation unit configured to evaluate the power-saving behavior of the user with respect to the power consumption device based on the estimation and the power consumption information.

### TECHNICAL FIELD

The present invention relates to a power-saving evaluation system that evaluates power-saving behavior of a user.

### BACKGROUND ART

Patent Literature 1 discloses a system that encourages a user to take power-saving behavior and enables the user to enjoy an advantage. In this system, a card company server acquires a power usage amount in the home of the user and records the power usage amount as household appliance energization information. In addition, in a case in which the user purchases a product or a service using a card, purchase information including a purchase date and time and a purchase location is acquired and recorded as a purchase history. Then, based on the purchase history, the behavior related to the purchase of the user using the card is estimated for each day and recorded as a user behavior record. Then, the card company server evaluates a power-saving amount in the home and the purchase behavior of the user using the card based on the household appliance energization information and the user behavior record, and determines an incentive to be given to the user in accordance with the evaluation.

### CITATION LIST

### Patent Literature

[Patent Literature 1] Japanese Unexamined Patent Publication No. 2016-157472

### SUMMARY OF INVENTION

### Technical Problem

In order to cause the user to perform the power-saving behavior, it is extremely important to determine and evaluate specific power-saving behavior taken by the user, and make the user aware of the specific power-saving behavior. Although the system disclosed in Patent Literature 1 evaluates the power-saving amount, the system only evaluates the power-saving amount for the entire home. In addition, the power-saving amount described in Patent Literature 1 is not necessarily evaluated from the viewpoint of the result of the power-saving behavior taken by the user. Therefore, from the viewpoint of determining and evaluating the specific power-saving behavior taken by the user, the system disclosed in Patent Literature 1 is not necessarily sufficient.

In addition, there is a home energy management system (HEMS) as a system for supporting power-saving in the home. By using the HEMS, it is possible to accurately measure a change in power consumption in the home. However, in order to use the HEMS, it is required to introduce an expensive power measurement device and monitor into the house. Further, in order to efficiently operate the HEMS, it is required to install a storage battery and a solar panel. Therefore, an introduction cost is high for a general home, which is a heavy burden. In addition, even in a case in which the power consumption can be measured by the HEMS, it is difficult to clearly discriminate whether a reduction in the power consumption is intentional, that is, due to a result of the user taking the power-saving behavior, or is accidental. Therefore, from the viewpoint of determining and evaluating the specific power-saving behavior taken by the user, the HEMS is also not necessarily sufficient.

An embodiment of the present invention has been made in consideration of the above-described circumstances, and an object of the embodiment of the present invention is to provide a power-saving evaluation system that can simply and appropriately evaluate power-saving behavior of a user.

### Solution to Problem

In order to achieve the above-described object, an embodiment of the present invention provides a power-saving evaluation system that evaluates power-saving behavior of a user with respect to a power consumption device that operates while consuming power and of which power consumption is adjustable by an operation of the user, the power-saving evaluation system including: a radio wave intensity information acquisition unit configured to acquire radio wave intensity information indicating an intensity of a radio wave related to short-range wireless communication, the radio wave being transmitted from the power consumption device and detected in a device carried by the user; an operation estimation unit configured to estimate whether or not the user is operating the power consumption device based on the radio wave intensity information acquired by the radio wave intensity information acquisition unit; a power consumption information acquisition unit configured to acquire power consumption information indicating the power consumption of the power consumption device; and an evaluation unit configured to evaluate the power-saving behavior of the user with respect to the power consumption device based on the estimation by the operation estimation unit and the power consumption information acquired by the power consumption information acquisition unit.

In the power-saving evaluation system according to the embodiment of the present invention, the power-saving behavior of the user with respect to the power consumption device is evaluated based on the estimation of whether or not the user is operating the power consumption device and the power consumption information. In addition, since the radio wave related to the short-range wireless communication transmitted from the power consumption device is used for the estimation, it is not required to provide new equipment or a new function for evaluating the power-saving behavior on the power consumption device side as long as the power consumption device has a function of using the radio wave. As described above, with the power-saving evaluation system according to the embodiment of the present invention, it is possible to simply and appropriately evaluate the power-saving behavior of the user.

### Advantageous Effects of Invention

According to the embodiment of the present invention, it is possible to simply and appropriately evaluate the power-saving behavior of the user.

### BRIEF DESCRIPTION OF DRAWINGS

FIG. 1 is a diagram showing a configuration of a power-saving evaluation system according to an embodiment of the present invention.

FIG. 2 is a diagram schematically showing an example of a TxPower value (RSSI) that is an intensity of a radio wave used for estimating a distance between a mobile terminal (user who carries the mobile terminal) and a power consumption device, for each power consumption device.

FIG. 3 is an example of a table for each power consumption device that stores the TxPower value (RSSI) that is the intensity of the radio wave used for estimating the distance between the mobile terminal (user who carries the mobile terminal) and the power consumption device.

FIG. 4 is a diagram showing the estimation of the distance between the mobile terminal (user who carries the mobile terminal) and the power consumption device.

FIG. 5 is an example of a table that stores information indicating the power consumption device closest to the user in a time series.

FIG. 6 is a diagram showing an example of a method that can be used for estimating a positional relationship between the mobile terminal (user who carries the mobile terminal) and the power consumption device.

FIG. 7 is an example of a table that stores power consumption information.

FIG. 8 is a graph of an example of power consumption indicated by the power consumption information.

FIG. 9 is a display example of an evaluation result output from the power-saving evaluation system.

FIG. 10 is a flowchart showing a process executed by a recommendation system according to the embodiment of the present invention.

FIG. 11 is a diagram showing a hardware configuration of the recommendation system according to the embodiment of the present invention.

### DESCRIPTION OF EMBODIMENTS

Hereinafter, an embodiment of a power-saving evaluation system according to the present invention will be described in detail with reference to the drawings. In the description of the drawings, the same elements are denoted by the same reference numerals, and the duplicated description will not be repeated.

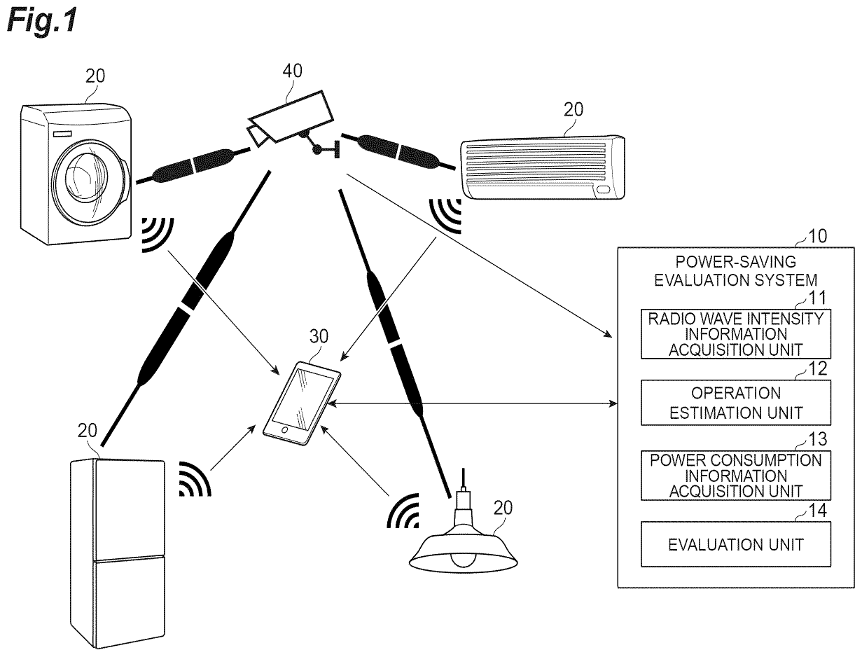

FIG. 1 shows a power-saving evaluation system 10 according to the present embodiment. The power-saving evaluation system 10 is a system (device) that evaluates power-saving behavior of a user with respect to a power consumption device 20. The power consumption device 20 is a device that operates while consuming power and of which power consumption can be adjusted by an operation of the user. The power consumption device 20 operates by, for example, receiving power such as commercial power from the outside and consuming the input power. In addition, the power consumption of the power consumption device 20 depends on an operation such as turning on and off of a power supply or a change in an operating state by the user.

The power consumption device 20 is, for example, household appliances (household electric appliances) used in the home of the user, and specifically, an air conditioner, a washing machine, lighting, and a refrigerator shown in FIG. 1. However, the power consumption device 20 may be a device other than household appliances. There may be a plurality of the power consumption devices 20 as shown in FIG. 1, or there may be one power consumption device 20. In addition, the power consumption device 20 related to the power-saving behavior of the user may be registered in a database of the power-saving evaluation system 10 in advance.

The power-saving behavior of the user in the present embodiment is behavior of reducing the power consumption of the power consumption device 20 that can be operated by the user. For example, the power-saving behavior of the user is behavior of reducing the power consumption by switching the power supply of the power consumption device 20 from an ON state to an OFF state. In addition, the power-saving behavior of the user may be behavior of reducing the power consumption in a state in which the power supply is maintained in the ON state, such as changing a temperature setting or an operation mode in air conditioning equipment.

In the present embodiment, the evaluation of the power-saving behavior of the user is, for example, to evaluate which power consumption device 20 the user has taken the behavior (has performed the operation) of reducing power consumption for and to what extent the power consumption has been reduced. In the present embodiment, the power-saving evaluation system 10 evaluates the power-saving behavior of the user with respect to the power consumption device 20 provided in the home. However, the power consumption device 20 as a target may be a power consumption device 20 other than the power consumption device 20 provided in the home.

The notification of the evaluation result of the power-saving behavior obtained by the power-saving evaluation system 10 is issued to the user as described later. The evaluation result for which the notification is issued is a result that indicates the contribution of the user's own power-saving behavior as an explicit indicator, and can also be an indicator of the user's future power-saving behavior. As described above, the power-saving behavior of the user is evaluated and presented by the power-saving evaluation system 10, so that it is possible to enhance the awareness of the user regarding the power-saving behavior.

The power-saving evaluation system 10 is configured by a computer such as a personal computer (PC) or a server device having a communication function. The power-saving evaluation system 10 may be configured by a plurality of computers. The power-saving evaluation system 10 can transmit and receive information to and from another device described later.

As a function required in the present embodiment, the power consumption device 20 has a function of short-range wireless communication. The short-range wireless communication is, for example, communication using Bluetooth Low Energy (BLE). BLE is one of Bluetooth (registered trademark) standards, and is a standard that enables communication with low power consumption. Recently, the Internet of Things (IoT) of the household appliances has progressed, and the household appliances with a built-in BLE function have been put on the market. As shown in FIG. 1, each power consumption device 20 constantly transmits the radio wave related to BLE during operation.

The function of the short-range wireless communication of the power consumption device 20 may be other than BLE. For example, the function of the short-range wireless communication of the power consumption device 20 may be a communication function using Zigbee (registered trademark) or a narrow area wireless communication method (for example, wireless local area network (LAN)).

As the device used in the present embodiment, there are a mobile terminal 30 and a power amount measurement device 40. The mobile terminal 30 is a terminal carried by the user whose power-saving behavior is evaluated. Specifically, for example, the mobile terminal 30 is a mobile communication terminal such as a smartphone, a smart watch, or a tablet terminal. A related-art device can be used as the mobile terminal 30.

The mobile terminal 30 has a function of detecting the intensity of the radio wave related to the short-range wireless communication transmitted from the power consumption device 20 and a function of specifying the power consumption device 20 that is a transmission source of the radio wave. For example, the mobile terminal 30 detects a received signal strength indicator (RSSI) as the intensity of the radio wave, and acquires a universally unique identifier (UUID) from the radio wave as information for specifying the power consumption device 20. The UUID is an identifier set in advance for each power consumption device 20, and is included in the radio wave transmitted from the power consumption device 20. The measurement of the radio wave intensity and the specification of the power consumption device 20 that is the transmission source of the radio wave can be performed by a related-art method. For example, the above operation may be performed by installing software using free source code, which is published on the Web, on the mobile terminal 30 and using the software.

The mobile terminal 30 acquires the RSSI and the UUID related to each power consumption device 20 as radio wave intensity information, for example, at regular intervals (for example, every 1 to several tens of seconds or every few minutes). Further, the radio wave intensity information includes a time when the RSSI is detected, and the time when the RSSI is detected is also grasped from the radio wave intensity information. The mobile terminal 30 has a communication function, and the mobile terminal 30 and the power-saving evaluation system 10 can transmit and receive information to and from each other by the communication function. The mobile terminal 30 transmits the acquired radio wave intensity information to the power-saving evaluation system 10. The mobile terminal 30 may transmit the radio wave intensity information in real time each time the RSSI is detected.

The power amount measurement device 40 is a device (system) that measures the power consumption of the power consumption device 20. The power amount measurement device 40 measures, for example, a power consumption amount of each power consumption device 20 at regular intervals (for example, every 1 to several tens of seconds or every several minutes). The measurement of the power consumption amount is performed, for example, by supplying power from an external power supply to the power consumption device 20 via the power amount measurement device 40 (for example, inserting the plug of the power consumption device 20, which is to be inserted into an outlet, into the power amount measurement device 40) and measuring a power amount input from the external power supply to the power consumption device 20. In addition, the power amount measurement device 40 may measure the power consumption of the power consumption device 20 by any method other than the method described above.

The power amount measurement device 40 has a communication function, and the power amount measurement device 40 and the power-saving evaluation system 10 can transmit and receive information to and from each other by the communication function. The power amount measurement device 40 transmits power consumption information indicating the power consumption of the power consumption device 20 obtained by the measurement to the power-saving evaluation system 10. A related-art device can be used as the power amount measurement device 40.

Subsequently, functions of the power-saving evaluation system 10 according to the present embodiment will be described. As shown in FIG. 1, the power-saving evaluation system 10 includes a radio wave intensity information acquisition unit 11, an operation estimation unit 12, a power consumption information acquisition unit 13, and an evaluation unit 14.

The radio wave intensity information acquisition unit 11 is a functional unit configured to acquire the radio wave intensity information indicating the intensity of the radio wave related to the short-range wireless communication, the radio wave being transmitted from the power consumption device 20 and detected in the mobile terminal 30 that is the device carried by the user. The radio wave intensity information acquisition unit 11 may acquire the radio wave intensity information related to a plurality of the power consumption devices 20.

The radio wave intensity information acquisition unit 11 receives and acquires the radio wave intensity information transmitted from the mobile terminal 30. For example, the radio wave intensity information is information indicating a time-series RSSI for each power consumption device 20 (for each UUID) as described above. The radio wave intensity information acquisition unit 11 outputs the acquired radio wave intensity information to the operation estimation unit 12. Alternatively, the radio wave intensity information acquisition unit 11 may store the acquired radio wave intensity information in the database of the power-saving evaluation system 10 to enable other functional units to refer to the radio wave intensity information. The acquisition of the radio wave intensity information may be performed by a method other than the method described above. In addition, the radio wave intensity information may be information other than the information described above as long as the information indicates the intensity of the radio wave related to the short-range wireless communication and enables the use of the following functions of the power-saving evaluation system 10, the radio wave being transmitted from the power consumption device 20 and detected in the mobile terminal 30 that is the device carried by the user.

The operation estimation unit 12 is a functional unit configured to estimate whether or not the user is operating the power consumption device 20 based on the radio wave intensity information acquired by the radio wave intensity information acquisition unit 11. The operation estimation unit 12 may estimate a positional relationship between the user and the power consumption device 20 based on the radio wave intensity information acquired by the radio wave intensity information acquisition unit 11, and estimate whether or not the user is operating the power consumption device 20 based on the estimated positional relationship. The operation estimation unit 12 may estimate the power consumption device being operated by the user based on the radio wave intensity information acquired by the radio wave intensity information acquisition unit 11.

The operation estimation unit 12 performs, for example, the estimation as follows. The operation estimation unit 12 inputs the radio wave intensity information from the radio wave intensity information acquisition unit 11. The operation estimation unit 12 estimates a distance between the user (current position of the user at the time) and the power consumption device 20 for each time when the intensity of the radio wave is detected by the mobile terminal 30 and for each power consumption device 20, based on the RSSI of the input radio wave intensity information. Since the mobile terminal 30 is carried by the user, a position of the mobile terminal 30 can be regarded as a position of the user. The operation estimation unit 12 estimates a distance between the mobile terminal 30 and the power consumption device 20 as the distance between the user and the power consumption device 20. The intensity of the radio wave transmitted from the power consumption device 20 and detected in the mobile terminal 30 corresponds to the distance between the mobile terminal 30 and the power consumption device 20. The intensity of the detected radio wave becomes greater as the distance between the mobile terminal 30 and the power consumption device 20 becomes smaller, and the intensity of the detected radio wave becomes weaker as the distance between the mobile terminal 30 and the power consumption device 20 becomes greater.

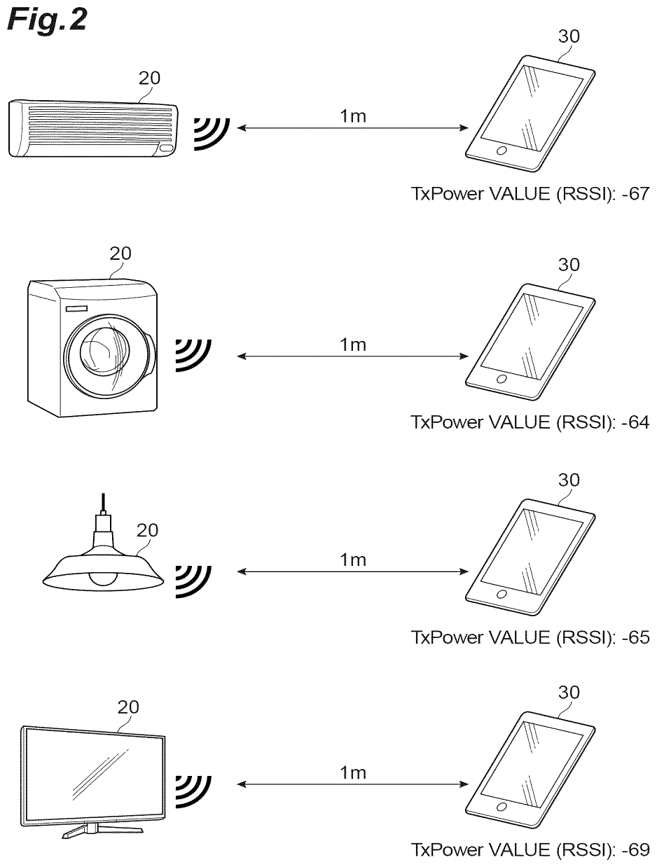

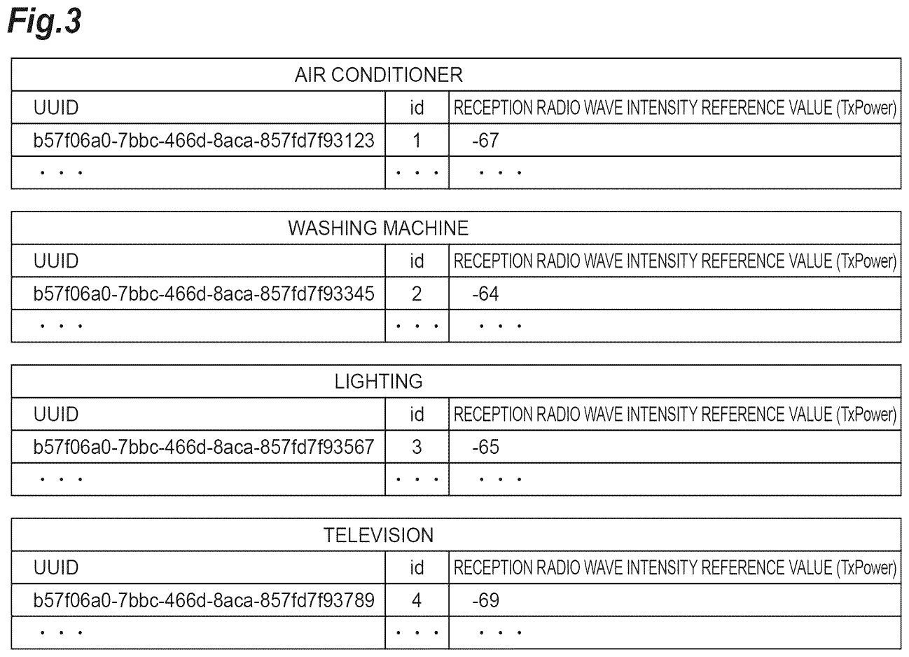

For the above-described estimation by the operation estimation unit 12, as shown in FIG. 2, the database of the power-saving evaluation system 10 stores in advance a TxPower value (RSSI), which is the intensity of the radio wave detected by the mobile terminal 30 when the distance between the mobile terminal 30 and the power consumption device 20 is a distance (for example, 1 m) set in advance. The intensity of the radio wave transmitted from the power consumption device 20 may depend on the power consumption device 20. Therefore, as shown in FIG. 2, the TxPower value stored in the operation estimation unit 12 may depend on the power consumption device 20. The TxPower value can be obtained by, for example, a measurement performed in advance. FIG. 3 shows an example of the TxPower value stored in the database of the power-saving evaluation system 10. As shown in FIG. 3, the TxPower value is stored in association with the UUID and an id of the power consumption device 20 (air conditioner, washing machine, lighting, television) for each power consumption device 20. The id is an identifier set in advance for each power consumption device 20. In the power-saving evaluation system 10, the power consumption device 20 may be identified by the id.

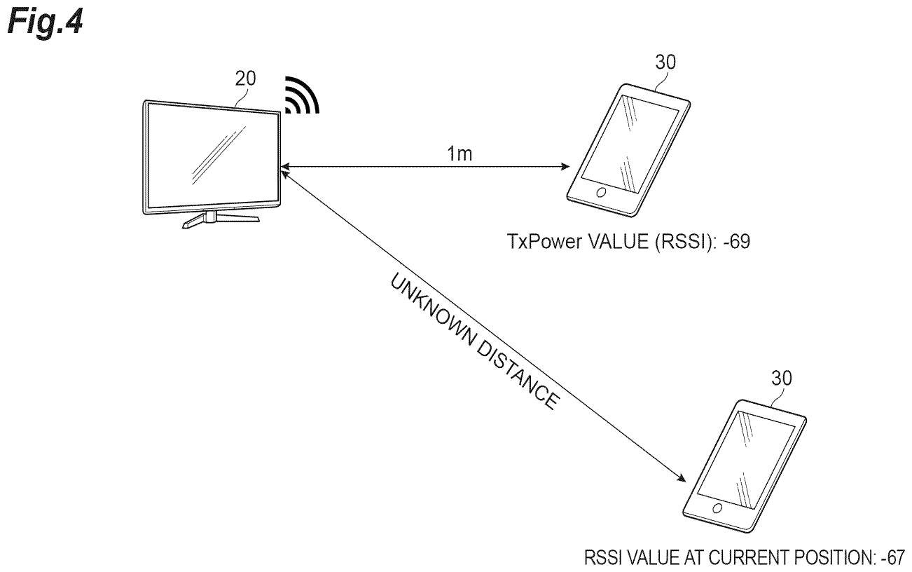

As shown in FIG. 4, the operation estimation unit 12 estimates a distance (distance denoted as an unknown distance in FIG. 4) between the user and the power consumption device 20 by using the RSSI of the radio wave intensity information and the TxPower value stored in advance. For example, the operation estimation unit 12 stores in advance an expression for estimating the distance from the RSSI of the radio wave intensity information and the TxPower value stored in advance, and estimates the distance based on the expression. The above-described expression for estimating a distance Distance (m) is, for example, the following expression.

$$Distance = {10}^{\frac{TxPower - RSSI}{10 \times N}} \qquad [ Math . 1 ]$$

Here, N is an environmental variable, and N=2 in a free space (ideal space without an obstacle). For the example shown in FIG. 4, in a case in which the distance between the user and the power consumption device 20 (television) is computed with N=2, the distance is as follows.

$${10}^{\frac{- 69 - ( - 67 )}{10 \times 2}} = 0.79432823472 m \qquad [ Math . 2 ]$$

The operation estimation unit 12 compares the distances related to the respective power consumption device 20 for each time, and estimates the power consumption device 20 closest to the user for each time. For example, in a case in which the distance at the same time is television<air conditioner<washing machine<lighting, it is estimated that the television is the power consumption device 20 closest to the user at the time. In addition, in a case in which the distance between the user and all the power consumption devices 20 is equal to or greater than a preset threshold value, the operation estimation unit 12 may estimate that there is no power consumption device 20 closest to the user.

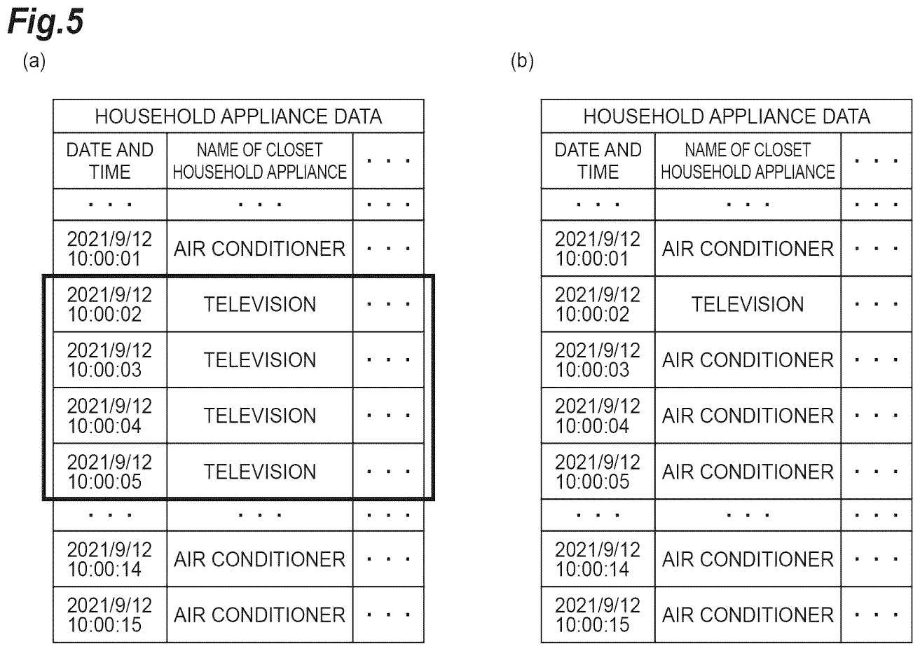

The operation estimation unit 12 holds the power consumption device 20 closest to the user in time series for a certain period in the database of the power-saving evaluation system 10. Examples of the information held by the operation estimation unit 12 are shown in (a) of FIG. 5 and (b) of FIG. 5.

In the present embodiment, the operation of the user on the power consumption device 20 is performed by the user approaching the power consumption device 20 to be operated. Based on the premise, the operation estimation unit 12 estimates the power consumption device 20 that is the power consumption device 20 closest to the user continuously for a preset time (for example, 4 seconds or more), as the power consumption device 20 being operated by the user in the time period, with reference to the held information. In the example shown in (a) of FIG. 5, since the television is the power consumption device 20 closest to the user continuously for 4 seconds or more (portion surrounded by a thick line in the table), it is estimated that the television is the power consumption device 20 being operated by the user. In the example shown in (b) of FIG. 5, since there is no power consumption device 20 closest to the user continuously for 4 seconds or more, it is estimated that there is no power consumption device 20 being operated by the user (user is not operating any power consumption device 20).

The operation estimation unit 12 outputs information indicating an estimation result, specifically, information indicating the power consumption device 20 estimated to being operated by the user for each time period (time) to the evaluation unit 14. Alternatively, the operation estimation unit 12 may store information indicating the power consumption device 20 estimated to being operated by the user in each time period (time) in the database of the power-saving evaluation system 10, and enable other functional units to refer to the information.

The estimation of the distance between the user and the power consumption device 20 does not necessarily have to be performed by the method described above, and need only be performed based on the radio wave intensity information. In addition, a positional relationship between the user and the power consumption device 20 other than the distance between the user and the power consumption device 20 may be estimated based on the radio wave intensity information, and whether or not the user is operating the power consumption device 20 may be estimated based on the estimated positional relationship.

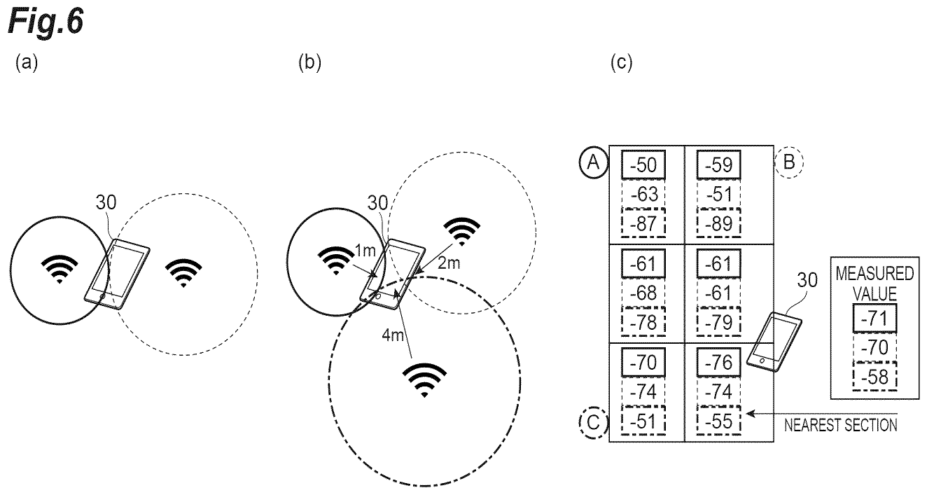

For example, an estimation technology using a radio wave transmitted from a related-art beacon (corresponding to the power consumption device 20 according to the present embodiment) and detected by the mobile terminal 30 may be used for the estimation of the positional relationship between the user and the power consumption device 20. For example, a technology (proximity method) of estimating which beacon among the installed beacons is close to the mobile terminal 30, as shown in (a) of FIG. 6 and also shown in the above-described embodiment, may be used. In addition, a technology (three-point measurement method) of installing a plurality of beacons with determined coordinates, measuring radio wave intensities of the beacons, and computing a relative position of the mobile terminal 30 to the beacons from the radio wave intensities, as shown in (b) of FIG. 6, may be used.

In addition, a technology (fingerprint method) of installing a plurality of beacons with determined coordinates, measuring the radio wave intensities (corresponding to numerical values in each square) from the beacons detected for each of a plurality of sections (corresponding to each square in the drawing) in advance, and using the radio wave intensities, as shown in (c) of FIG. 6, may be used. In this technology, a location in which the radio wave intensities related to the plurality of beacons measured in advance and the radio wave intensities related to the plurality of beacons at the time of the estimation are most similar is estimated as the position of the mobile terminal 30. Depending on the technology to be used, it is required to store (pre-register) the position of the power consumption device 20 in the power-saving evaluation system 10 in advance.

In addition, in a case in which there is only one power consumption device 20 as the target, the operation estimation unit 12 need only estimate whether or not the user is operating the one power consumption device 20 based on the radio wave intensity information related to the one power consumption device 20.

The power consumption information acquisition unit 13 is a functional unit configured to acquire the power consumption information indicating the power consumption of the power consumption device 20. The power consumption information acquisition unit 13 may acquire the power consumption information indicating the power consumption of the plurality of power consumption devices 20.

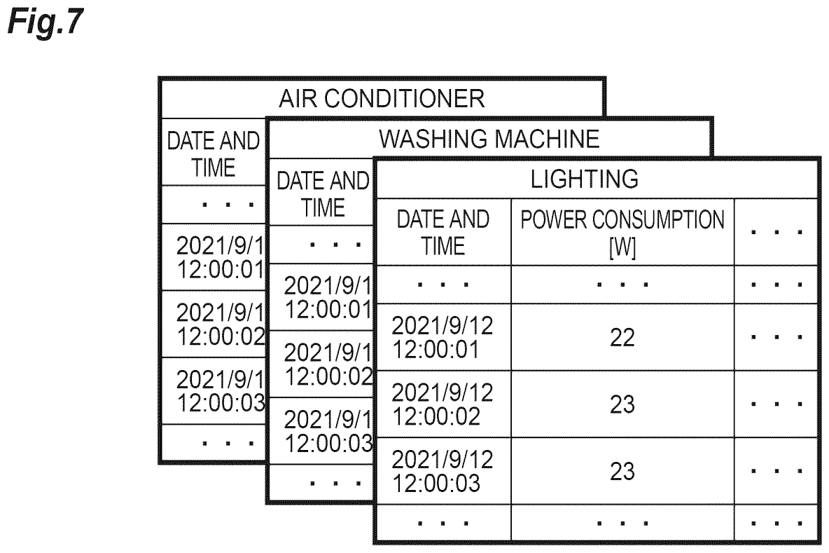

The power consumption information acquisition unit 13 receives and acquires the power consumption information transmitted from the power amount measurement device 40. For example, the power consumption information is information indicating the power consumption amount (for example, in units of [W]) in time series for each power consumption device 20 as described above. FIG. 7 shows an example of the power consumption information. The power consumption information acquisition unit 13 outputs the acquired power consumption information to the evaluation unit 14. Alternatively, the power consumption information acquisition unit 13 may store the acquired power consumption information in the database of the power-saving evaluation system 10 to enable other functional units to refer to the power consumption information. The acquisition of the power consumption information may be performed by a method other than the method described above. In addition, the power consumption information may be information other than the above-described information as long as the information indicates the power consumption of the power consumption device 20 and can be used for the following functions in the power-saving evaluation system 10.

The evaluation unit 14 is a functional unit configured to evaluate the power-saving behavior of the user with respect to the power consumption device 20 based on the estimation by the operation estimation unit 12 and the power consumption information acquired by the power consumption information acquisition unit 13. The evaluation unit 14 may estimate the power consumption device 20 for which the user has performed the operation related to the power-saving behavior based on the estimation by the operation estimation unit 12 and the power consumption information acquired by the power consumption information acquisition unit 13. The evaluation unit 14 may estimate the power consumption amount reduced by the power-saving behavior of the user with respect to the power consumption device 20.

In the present embodiment, for example, the power-saving behavior of the user is evaluated based on the idea that in a case in which the power consumption of the power consumption device 20 that is (estimated to) being operated by the user is significantly reduced from the time of the user's operation, the user has performed the power-saving behavior with respect to the power consumption device 20. The evaluation unit 14 evaluates the power-saving behavior of the user with respect to the power consumption device 20, for example, as follows. Specifically, the evaluation unit 14 determines whether or not the user performs the operation related to the power-saving behavior with respect to the power consumption device 20, the power consumption device 20 that is the target of the power-saving behavior, and the power consumption amount reduced by the power-saving behavior, as the evaluation of the power-saving behavior of the user.

The evaluation unit 14 inputs the information indicating the estimation result from the operation estimation unit 12. The evaluation unit 14 inputs the power consumption information from the power consumption information acquisition unit 13. The evaluation unit 14 sets a standby period to be used for the evaluation of the power-saving behavior based on the time period in which it is estimated that the user is operating the power consumption device 20 indicated by the estimation result of the operation estimation unit 12. The standby period is a period for determining whether or not the user is performing the operation related to the power-saving behavior with respect to the power consumption device 20. For example, the standby period is the time period in which it is estimated that the user is operating the power consumption device 20 indicated by the estimation result of the operation estimation unit 12 and a period of a certain length of time following the time period.

The evaluation unit 14 refers to the power consumption during the standby period indicated by the power consumption information for the power consumption device 20 being operated by the user indicated by the estimation result of the operation estimation unit 12. The evaluation unit 14 determines whether or not the power consumption is significantly reduced during the standby period, and determines whether or not the user is performing the operation related to the power-saving behavior with respect to the power consumption device 20.

For example, the evaluation unit 14 performs the determination as follows. The evaluation unit 14 computes an average value of the power consumption in a period of a preset length immediately before the standby period. The evaluation unit 14 compares a reference value based on the average value (for example, a value of a certain ratio of the average value that is less than the average value, or a value obtained by subtracting a certain value from the average value) with the power consumption at each time during the standby period. In a case in which there is the power consumption equal to or less than the reference value during the standby period, the evaluation unit 14 determines that the user is performing the operation related to the power-saving behavior with respect to the power consumption device 20. Otherwise, the evaluation unit 14 determines that the user is not performing the operation related to the power-saving behavior with respect to the power consumption device 20. In addition, in a case in which the power consumption during the standby period is equal to or less than the reference value continuously for a preset period, the evaluation unit 14 may determine that the user is performing the power-saving behavior with respect to the power consumption device 20. In addition, the evaluation unit 14 may estimate the type of the power-saving behavior taken by the user (for example, turning off the power supply) based on a reduction amount in the power consumption, a way of reducing the power consumption, or the like, based on a determination criterion stored in advance.

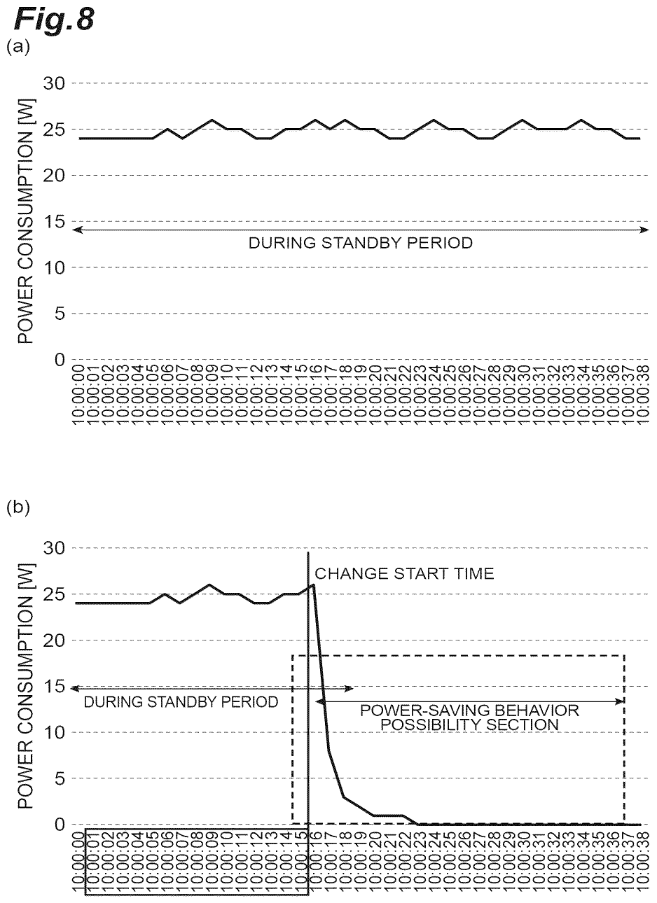

FIG. 8 shows a graph of an example of the power consumption indicated by the power consumption information. In the graph of FIG. 8, a horizontal axis is a time, and a vertical axis is the power consumption of the power consumption device 20. As shown in the graph of (a) of FIG. 8, in a case in which the fluctuation in the power consumption during the standby period is small, it is determined that the user is not performing the operation related to the power-saving behavior with respect to the power consumption device 20 in accordance with the above-described determination criterion. As shown in the graph of (b) of FIG. 8, in a case in which the power consumption is significantly reduced during the standby period, it is determined that the user is performing the operation related to the power-saving behavior with respect to the power consumption device 20 in accordance with the above-described determination criterion.

In a case in which it is determined that the user is performing the operation related to the power-saving behavior with respect to the power consumption device 20, the evaluation unit 14 estimates the power consumption amount reduced by the power-saving behavior. The evaluation unit 14 sets a power-saving behavior possibility section that is a period for estimating the power consumption amount based on a time when the power consumption during the standby period is equal to or less than the reference value. The power-saving behavior possibility section is, for example, a period from a time (change start time) that is traced back by a predetermined short time from the time when the power consumption during the standby period is equal to or less than the reference value to a time when a predetermined length has elapsed. An example of the power-saving behavior possibility section is shown in the graph in (b) of FIG. 8.

The evaluation unit 14 estimates the power consumption amount reduced by the power-saving behavior, for example, using, as a reference, a case in which the power of the reference value is used in the power-saving behavior possibility section. The evaluation unit 14 computes a power of a difference obtained by subtracting the power consumption indicated by the power consumption information from the power of the reference value for each time of the power-saving behavior possibility section, and sets the sum of the power of the difference for each time of the power-saving behavior possibility section as the reduced power consumption amount. In addition, the evaluation unit 14 may compute a reduced electricity charge based on the reduced power consumption amount by using a computation expression stored in advance.

The evaluation unit 14 outputs information indicating the evaluation result of the power-saving behavior of the user with respect to the power consumption device 20. For example, the evaluation unit 14 may output information indicating the evaluation result in a case in which it is determined that the user is performing the operation related to the power-saving behavior with respect to the power consumption device 20. The output of the information indicating the evaluation result is performed by, for example, transmitting the information to the mobile terminal 30. In the mobile terminal 30, the information is received, and the user is notified of the information by display and the like. With this notification, the user can recognize the nature of the user's own power-saving behavior.

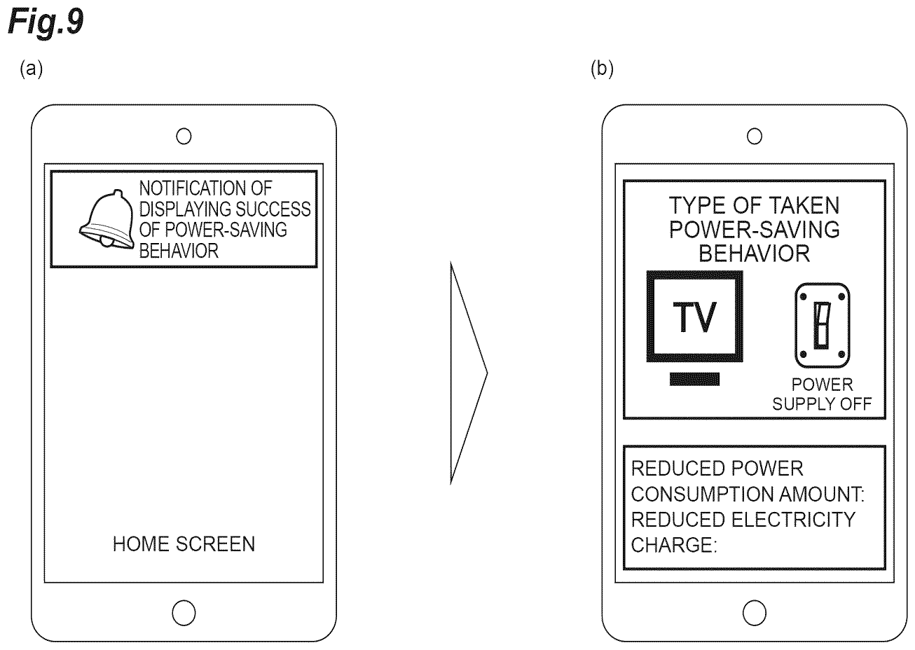

FIG. 9 shows an example of display for notifying the user of the evaluation result in the mobile terminal 30. First, notification indicating that the user has performed the power-saving behavior is issued as shown in (a) of FIG. 9, and then notification indicating the content of the power-saving behavior is issued as shown in (b) of FIG. 9. The content of the power-saving behavior may include the power consumption device 20 that is the target of the power-saving behavior, the type of the power-saving behavior, and the power consumption amount and the electricity charge reduced by the power-saving behavior. The output of the evaluation result by the evaluation unit 14 may be performed by an output destination other than the output destination described above and a method other than the method described above.

The evaluation unit 14 performs the evaluation, for example, at a predetermined timing in and after a timing at which the information for the evaluation can be acquired. The evaluation unit 14 performs the evaluation for a time period that is traced back by a predetermined duration from a certain point in time, for example, at regular intervals. The processes via the radio wave intensity information acquisition unit 11, the operation estimation unit 12, and the power consumption information acquisition unit 13 can be performed at any timing until the evaluation unit 14 performs the evaluation.

The evaluation unit 14 may evaluate the power-saving behavior of the user with respect to the power consumption device 20 by a method other than the above-described method as long as the evaluation is based on the estimation by the operation estimation unit 12 and the power consumption information acquired by the power consumption information acquisition unit 13. In addition to or instead of the above-described items, the evaluation unit 14 may evaluate the power-saving behavior of the user with respect to the power consumption device 20 for items other than the above-described items. The functions of the power-saving evaluation system 10 according to the present embodiment are as described above.

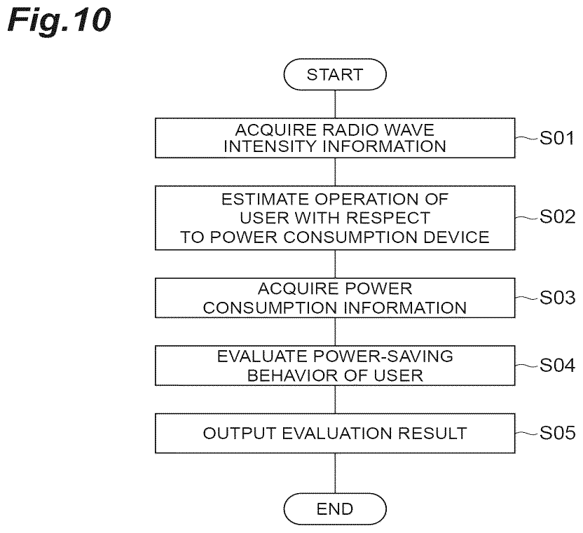

Subsequently, a process executed by the power-saving evaluation system 10 according to the present embodiment (operation method performed by the power-saving evaluation system 10) will be described with reference to the flowchart of FIG. 10. In the present process, first, the radio wave intensity information acquisition unit 11 acquires the radio wave intensity information (S01). Then, the operation estimation unit 12 estimates whether or not the user is operating the power consumption device 20 based on the radio wave intensity information (S02).

In addition, the power consumption information acquisition unit 13 acquires the power consumption information indicating the power consumption of the power consumption device 20 (S03). Since the processes (S01 and S02) via the radio wave intensity information acquisition unit 11 and the operation estimation unit 12 and the process (S03) via the power consumption information acquisition unit 13 are independent of each other, the processes does not necessarily have to be performed in the above-described order.

Subsequently, after the processes (S01 and S02) via the radio wave intensity information acquisition unit 11 and the operation estimation unit 12 and the process (S03) via the power consumption information acquisition unit 13, the evaluation unit 14 evaluates the power-saving behavior of the user with respect to the power consumption device 20 based on the estimation by the operation estimation unit 12 and the power consumption information (S04). Then, the evaluation unit 14 outputs the information indicating the evaluation result (S05). The process executed by the power-saving evaluation system 10 according to the present embodiment is as described above.

In the present embodiment, the power-saving behavior of the user with respect to the power consumption device 20 is evaluated based on the estimation of whether or not the user is operating the power consumption device 20 and the power consumption information. In addition, since the radio wave that is related to the short-range wireless communication such as BLE and is transmitted from the power consumption device 20 is used for the estimation, in a case in which the power consumption device 20 has a function of using the radio wave, it is not required to provide new equipment or a new function for evaluating the power-saving behavior on the power consumption device 20 side. Therefore, according to the present embodiment, it is possible to inexpensively estimate detailed power-saving behavior of the user and the effect thereof, which have not been measurable without a high introduction cost so far. As described above, according to the present embodiment, it is possible to simply and appropriately evaluate the power-saving behavior of the user. As a result, for example, by presenting the contribution of the user's own power-saving behavior, which has been unclear so far, to the user as an explicit indicator, the contribution can be used as an indicator of the future power-saving behavior of the user.

In addition, as in the present embodiment, the operation estimation unit 12 may estimate a positional relationship between the user and the power consumption device 20 (for example, the distance between the user and the power consumption device 20 as described above) based on the radio wave intensity information, and estimate whether or not the user is operating the power consumption device 20 based on the estimated positional relationship. With this configuration, it is possible to appropriately and reliably estimate whether or not the user is operating the power consumption device 20 based on the radio wave intensity information. However, the operation estimation unit 12 does not necessarily have to estimate the positional relationship between the user and the power consumption device 20, and need only estimate whether or not the user is operating the power consumption device 20 based on the radio wave intensity information.

In addition, as in the present embodiment, the plurality of power consumption devices 20 may be used as the evaluation targets (for example, the evaluation in the home in which the plurality of power consumption devices 20 are present), and the evaluation unit 14 may estimate the power consumption device 20 for which the user has performed the operation related to the power-saving behavior. With this configuration, even in a case in which the plurality of power consumption devices 20 are the evaluation targets, the power-saving behavior of the user can be simply and appropriately evaluated. However, the power-saving evaluation system 10 does not have to premise the plurality of power consumption devices 20, and may evaluate the power-saving behavior of the user with respect to one power consumption device 20.

In addition, as in the present embodiment, the evaluation unit 14 may estimate the power consumption amount reduced by the power-saving behavior of the user with respect to the power consumption device 20. With this configuration, for example, it is possible to notify the user of information useful for raising the user's awareness of the power-saving behavior, such as the power consumption amount reduced by the power-saving behavior. However, in the power-saving evaluation system 10, the estimation of the power consumption amount does not necessarily have to be performed.

The block diagram used in the description of the above-described embodiment shows blocks in functional units. These functional blocks (components) are implemented by any combination of at least one of hardware or software. In addition, a method of implementing each functional block is not particularly limited. That is, each functional block may be implemented by using one device that is physically or logically coupled, or may be implemented by connecting two or more devices that are physically or logically separated directly or indirectly (for example, using wired or wireless connections), and using these plurality of devices. The functional block may be implemented by combining software with the one device or the plurality of devices described above.

The functions include, but are not limited to, determining, determining, judging, calculating, computing, processing, deriving, investigating, looking up, search, inquiry, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, and assigning. For example, the functional block (component) that functions to perform transmission is referred to as a transmitting unit or a transmitter. In any case, as described above, the method of implementing the above-described method is not particularly limited.

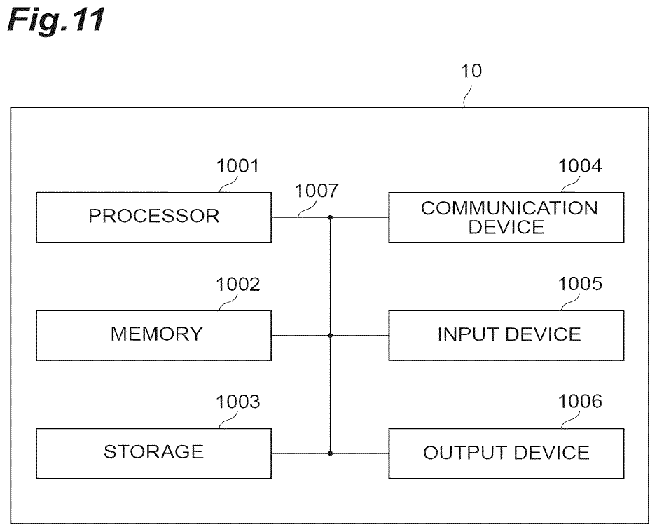

For example, the power-saving evaluation system 10 in one embodiment of the present disclosure may function as a computer that performs information processing of the present disclosure. FIG. 11 is a diagram showing an example of a hardware configuration of the power-saving evaluation system 10 according to one embodiment of the present disclosure. The power-saving evaluation system 10 may be physically configured as a computer device including a processor 1001, a memory 1002, a storage 1003, a communication device 1004, an input device 1005, an output device 1006, a bus 1007, and the like. Further, the mobile terminal 30 and the power amount measurement device 40 may also include the hardware described here.

In the following description, the term “device” can be interpreted as a circuit, a device, a unit, or the like. The hardware configuration of the power-saving evaluation system 10 may include one or a plurality of devices shown in the drawing, or may not include some of the devices.

In a case in which a predetermined software (program) is loaded on hardware such as the processor 1001 and the memory 1002, the processor 1001 performs arithmetic operations to control the communication via the communication device 1004 or control at least one of reading or writing of data in the memory 1002 and the storage 1003, thereby implementing each of the functions of the power-saving evaluation system 10.

The processor 1001 controls the entire computer by, for example, operating an operating system. The processor 1001 may be configured by a central processing unit (CPU) including an interface with a peripheral device, a control device, an arithmetic device, a register, and the like. For example, each function in the power-saving evaluation system 10 described above may be implemented by the processor 1001.

The processor 1001 reads out a program (program code), a software module, data, and the like from at least one of the storage 1003 or the communication device 1004 to the memory 1002, and executes various processes in accordance with the program, the software module, the data, and the like. As the program, a program that causes the computer to execute at least a part of the operations described in the above-described embodiment is used. For example, each function in the power-saving evaluation system 10 may be stored in the memory 1002 and implemented by a control program that operates in the processor 1001. Various processes described above are described as being executed by one processor 1001, but may be simultaneously or sequentially executed by two or more processors 1001. The processor 1001 may be implemented by one or more chips. The program may be transmitted from a network via an electric telecommunication line.

The memory 1002 is a computer-readable recording medium, and may be configured by, for example, at least one of a read-only memory (ROM), an erasable programmable ROM (EPROM), an electrically erasable programmable ROM (EEPROM), or a random-access memory (RAM). The memory 1002 may be referred to as a register, a cache, a main memory (main storage device), and the like. The memory 1002 can store an executable program (program code), a software module, and the like for performing the information processing according to one embodiment of the present disclosure.

The storage 1003 is a computer-readable recording medium, and may be configured by at least one of, for example, an optical disk such as a compact disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, or a magnetic strip. The storage 1003 may be referred to as an auxiliary storage device. The storage medium provided in the power-saving evaluation system 10 may be, for example, a database including at least one of the memory 1002 or the storage 1003, a server, or another appropriate medium.

The communication device 1004 is hardware (transceiver) for performing communication between computers via at least one of a wired network or a wireless network, and is also referred to as, for example, a network device, a network controller, a network card, a communication module, and the like.

The input device 1005 is an input device (for example, a keyboard, a mouse, a microphone, a switch, a button, a sensor, and the like) that receives an input from the outside. The output device 1006 is an output device (for example, a display, a speaker, an LED lamp, and the like) that performs output to the outside. The input device 1005 and the output device 1006 may be configured integrally (for example, a touch panel).

Each device such as the processor 1001 or the memory 1002 is connected by the bus 1007 for communicating information. The bus 1007 may be configured by a single bus or different buses between the respective devices.

The power-saving evaluation system 10 may include hardware such as a microprocessor, a digital signal processor (DSP), an application-specific integrated circuit (ASIC), a programmable logic device (PLD), or a field programmable gate array (FPGA), and some or all of the functional blocks may be implemented by the hardware. For example, the processor 1001 may be implemented by using at least one of these types of hardware.

An order of the processing procedures, sequences, flowcharts, and the like of each aspect/embodiment described in the present disclosure may be interchanged as long as there is no contradiction. For example, in the method described in the present disclosure, elements of various steps are presented using an illustrative order, and the method is not limited to the presented specific order.

The input and output information and the like may be stored in a specific location (for example, a memory) or may be managed using a management table. The information and the like input and output can be overwritten, updated, or added. The output information and the like may be deleted. The input information and the like may be transmitted to another device.

The judgement may be performed by a value represented by 1 bit (0 or 1), may be performed by a Boolean value (true or false), or may be performed by comparison of numerical values (for example, comparison with a predetermined value).

Each aspect/embodiment described in the present disclosure may be used alone, in combination, or switched with each other in execution. In addition, notification of predetermined information (for example, notification of “X”) is not limited to being explicitly performed, and may be performed implicitly (for example, the notification of the predetermined information is not performed).

The present disclosure has been described in detail above, but it is clear to those skilled in the art that the present disclosure is not limited to the embodiment described in the present disclosure. The present disclosure can be implemented as a modification and change aspect without departing from the gist and scope of the present disclosure determined by the description of claims. Therefore, the description of the present disclosure is for illustrative purposes, and is not intended to limit the present disclosure in any way.

The software should be broadly construed to mean commands, command sets, codes, code segments, program codes, programs, sub-programs, software modules, applications, software applications, software packages, routines, sub-routines, objects, executable files, execution threads, procedures, functions, and the like, regardless of whether the software is referred to as software, firmware, middleware, microcode, or a hardware description language, or is called by other names.

Further, software, commands, information, and the like may be transmitted and received via a transmission medium. For example, in a case in which the software is transmitted from a website, a server, or another remote source using at least one of a wired technology (coaxial cable, optical fiber cable, twisted pair, digital subscriber line (DSL), or the like) or a wireless technology (infrared, microwave, or the like), at least one of the wired technology or the wireless technology is included in the definition of the transmission medium.

The terms “system” and “network” used in the present disclosure are used interchangeably.

The information, the parameter, and the like described in the present disclosure may be represented by using an absolute value, may be represented by using a relative value from a predetermined value, or may be represented by using corresponding another information.

The terms “determining” and “determining” used in the present disclosure may include a wide variety of operations. The “determining” and the “determining” may include, for example, regarding judging, calculating, computing, processing, deriving, investigating, looking up, search, inquiry (for example, search in a table, a database or another data structure), and ascertaining as “determining” and “determining”. In addition, the “determining” and the “determining” may include regarding receiving (for example, receiving information), transmitting (for example, transmitting information), input, output, and accessing (for example, accessing data in a memory) as “determining” and “determining”. In addition, the “determining” and the “determining” may include regarding resolving, selecting, choosing, establishing, comparing, and the like as “determining” and “determining”. That is, the “determining” and the “determining” may include regarding that any operation is “determined” or “determined”. Further, “determining (determining)” may be interpreted as “assuming,” “expecting,” “considering,” or the like.

The terms “connected” and “coupled” or various variations thereof mean various direct or indirect connections or couplings between two or more elements, and it is possible to include presence of one or more intermediate elements between two elements that are “connected” or “coupled” to each other. The coupling or the connection between the elements may be physical, logical, or a combination thereof. For example, “connecting” may be interpreted as “accessing”. In a case of being used in the present disclosure, two elements can be considered to be “connected” or “coupled” to each other with one or more electrical wires, cables, and printed electrical connections, as well as with electromagnetic energy having wavelengths in the radio frequency, microwave, and light (both visible and invisible) regions, among other non-limiting and non-inclusive examples.

In the present disclosure, the phrase “based on” does not mean “based only on” unless otherwise specified. In other words, the phrase “based on” means both “based only on” and “based at least on”.

Any reference to an element using designations such as “first,” “second,” and the like used in the present disclosure does not generally limit the quantity or order of the elements. These designations may be used in the present disclosure as a convenient method of distinguishing between two or more elements. Accordingly, the reference to first and second elements does not imply that only two elements can be employed or that the first element should precede the second element in any manner.

In the present disclosure, in a case in which the terms “include,” “including,” and variations thereof are used, these terms are intended to be inclusive in the same manner as the term “comprising”. Further, the term “or” as used in the present disclosure is not intended to represent an exclusive logical OR.

In the present disclosure, for example, in a case in which an article is added by translation, such as “a”, “an”, and “the” in English, the present disclosure may include that a noun following these articles is in plural form.

In the present disclosure, the phrase “A and B are different” may mean that “A and B are different from each other”. The phrase may mean that “A and B are each different from C”. The terms “separated”, “coupled”, and the like may be interpreted in the same manner as “different”.

The power-saving evaluation system according to the present disclosure has the following configuration.
[1] A power-saving evaluation system that evaluates power-saving behavior of a user with respect to a power consumption device that operates while consuming power and of which power consumption is adjustable by an operation of the user, the power-saving evaluation system including: a radio wave intensity information acquisition unit configured to acquire radio wave intensity information indicating an intensity of a radio wave related to short-range wireless communication, the radio wave being transmitted from the power consumption device and detected in a device carried by the user; an operation estimation unit configured to estimate whether or not the user is operating the power consumption device based on the radio wave intensity information acquired by the radio wave intensity information acquisition unit; a power consumption information acquisition unit configured to acquire power consumption information indicating the power consumption of the power consumption device; and an evaluation unit configured to evaluate the power-saving behavior of the user with respect to the power consumption device based on the estimation by the operation estimation unit and the power consumption information acquired by the power consumption information acquisition unit.
[2] The power-saving evaluation system according to [1], in which the operation estimation unit estimates a positional relationship between the user and the power consumption device based on the radio wave intensity information acquired by the radio wave intensity information acquisition unit, and estimates whether or not the user is operating the power consumption device based on the estimated positional relationship.
[3] The power-saving evaluation system according to [1] or [2], in which the radio wave intensity information acquisition unit acquires radio wave intensity information related to a plurality of the power consumption devices, the operation estimation unit estimates the power consumption device that is being operated by the user based on the radio wave intensity information acquired by the radio wave intensity information acquisition unit, the power consumption information acquisition unit acquires power consumption information indicating power consumption of the plurality of power consumption devices, and the evaluation unit estimates the power consumption device for which the user has performed an operation related to the power-saving behavior based on the estimation by the operation estimation unit and the power consumption information acquired by the power consumption information acquisition unit.
[4] The power-saving evaluation system according to any one of [1] to [3], in which the evaluation unit estimates a power consumption amount reduced by the power-saving behavior of the user with respect to the power consumption device.

### REFERENCE SIGNS LIST

10: power-saving evaluation system
11: radio wave intensity information acquisition unit
12: operation estimation unit
13: power consumption information acquisition unit
14: evaluation unit
20: power consumption device
30: mobile terminal
40: power amount measurement device
1001: processor
1002: memory
1003: storage
1004: communication device
1005: input device
1006: output device
1007: bus

1. A power-saving evaluation system that evaluates power-saving behavior of a user with respect to a power consumption device that operates while consuming power and of which power consumption is adjustable by an operation of the user, the power-saving evaluation system comprising circuitry configured to:
to acquire radio wave intensity information indicating an intensity of a radio wave related to short-range wireless communication, the radio wave being transmitted from the power consumption device and detected in a device carried by the user;
estimate whether or not the user is operating the power consumption device based on the acquired radio wave intensity information;
acquire power consumption information indicating the power consumption of the power consumption device; and
evaluate the power-saving behavior of the user with respect to the power consumption device based on the estimation and the acquired power consumption information.

2. The power-saving evaluation system according to claim 1,
wherein the circuitry estimates a positional relationship between the user and the power consumption device based on the radio wave intensity information, and estimates whether or not the user is operating the power consumption device based on the estimated positional relationship.

3. The power-saving evaluation system according to claim 1,
wherein the circuitry acquires radio wave intensity information related to a plurality of the power consumption devices,
estimates the power consumption device that is being operated by the user based on the acquired radio wave intensity information,
acquires power consumption information indicating power consumption of the plurality of power consumption devices, and
estimates the power consumption device for which the user has performed an operation related to the power-saving behavior based on the estimation and the acquired power consumption information.

4. The power-saving evaluation system according to claim 1,
wherein the circuitry estimates a power consumption amount reduced by the power-saving behavior of the user with respect to the power consumption device.
